(19) United States
(12) Patent Application Publication
(10) Pub. No.: US 2008/0017464 A1
(43) Pub. Date: Jan. 24, 2008

(54) Collector cover for electric rail applications

(75) Inventors: Ovidiu Neiconi, Boynton Beach, FL (US); Bruno Gisonni, Lake Worth, FL (US)

Correspondence Address: IP LEGAL DEPARTMENT;TYCO FIRE & SECURITY SERVICES, ONE TOWN CENTER ROAD, BOCA RATON, FL, 33486, US

(73) Assignee: Sensormatic Electronics Corporation, Boca Raton, CA (US)

(21) Appl. No.: 11/490,931

(22) Filed: Jul. 19, 2006

(51) Int. Cl. B60L 5/38

(52) U.S. Cl. 191/45 R

(57) ABSTRACT

A collector cover for electric rail applications is provided which forms a complete assembly for capturing dust particles generated by electric rail systems. The cover includes complementary portions that are connected together to form a dust collecting device. The collector cover may include first and second side members which may be configured to form at least one cavity to receive therein particles from the collector. In one embodiment, the first and second side members can each include a recess forming a cavity when engaging the collector.

### BACKGROUND OF THE INVENTION

1. Field of the Invention

This invention relates generally to electric rail systems, and more particularly to track or rail mounted electric mobile surveillance systems.

2. Description of the Related Art

Moveable video surveillance systems, such as the SensorRail™ system, typically use metal collector brushes, also referred to as collectors, in contact with copper strips to both power a trolley motor and to provide data communication. For example, the trolley may include a total of four collectors, with two providing power and two providing communication of data. The collectors are typically mounted on the outside of the moveable trolley having a camera therein. The collector brushes are in substantially permanent contact with the copper strips when the trolley moves along a rail, for example, from one end of the rail to the other.

Due to continuous friction, over time, the collector brushes may wear-out; This wearing out process generates small particles that may deposit on different parts of the surveillance system, including, for example, a cowling covering the trolley and camera assembly. This deposited dust can affect the performance of the surveillance system, for example, degrading the image quality because particles on the cowling are in the field of view of the camera. Thus, cleaning is periodically performed to prevent video picture degradation. Further, during the cleaning process, some of the dust particles may end-up on equipment, supplies etc. in the environment where the rail operates, creating further problems and serious inconveniences. Additionally, the dust particles generated during operation are very small and tend to “stick” to smooth surfaces, making the cleaning process very difficult, thereby adding time and cost.

It is known to use special vacuum equipment in the cleaning process. However, this equipment is not always compatible with all systems, thereby adding complexity to the cleaning process. Further, the use of dedicated equipment adds extra cost.

### BRIEF DESCRIPTION OF THE INVENTION

In an embodiment, a collector cover is provided that may include a first side member and a second side member. The first and second side members may be configured to engage a collector and to form at least one cavity.

In another embodiment, a rail mounted electric surveillance system is provided that may include at least one camera, at least one rail and a trolley configured to support the camera and movably engaged with at least one rail. The rail mounted electric surveillance system further may include at least one collector connected to the trolley and configured to contact at least a portion of the rail. The rail mounted electric surveillance system also may include a cover removably connectable to the at least one collector.

In yet another embodiment, a method for reducing dust particle accumulation in an electric rail system is provided. The method may include configuring a cover to removably connect to a collector of the electric rail system and providing at least one cavity in the cover configured to collect therein dust particles from the collector.

### BRIEF DESCRIPTION OF THE DRAWINGS

For a better understanding of the various embodiments of the invention, together with other objects, features and advantages, reference should be made to the following detailed description which should be read in conjunction with the following figures wherein like numerals represent like parts.

FIG. 1 is a side elevation view of a rail mounted surveillance system in connection with which various embodiments of the invention may be implemented.

FIG. 2 is a perspective view of the rail mounted surveillance system of FIG. 1 with a portion removed to show a camera inside a cowling.

FIG. 3 is a side elevation view of a trolley of the rail mounted surveillance system of FIG. 1.

FIG. 4 is a front elevation view showing a rail portion of the rail mounted surveillance system of FIG. 1.

FIG. 5 is a perspective view of a trolley of the rail mounted surveillance system of FIG. 1.

FIG. 6 is a cross-sectional view showing collectors in connection with the rail of the rail mounted surveillance system of FIG. 1.

FIG. 7 is a perspective view of a cover for a collector constructed in accordance with an embodiment of the invention.

FIG. 8 is a perspective view of one side member of the cover of FIG. 7 against a collector.

FIG. 9 is a perspective view of a portion of one side member of the cover of FIG. 7 showing a recess.

FIG. 10 is a perspective view showing one step in the assembly of the cover of FIG. 7 to engage a collector.

FIG. 11 is a perspective view showing another step in the assembly of the cover of FIG. 7 to engage a collector.

FIG. 12 is a perspective view showing another step in the assembly of the cover of FIG. 7 to engage a collector.

FIG. 13 is a perspective view showing another step in the assembly of the cover of FIG. 7 to engage a collector.

FIG. 14 is a perspective view of two side members of a cover constructed in accordance with another embodiment of the invention.

FIG. 15 is a perspective view of the cover of FIG. 14 in an engaged position.

FIG. 16 is a side elevation view of a cover constructed in accordance with an embodiment of the invention engaged with a collector that is contacting a copper strip.

### DETAILED DESCRIPTION OF THE INVENTION

For simplicity and ease of explanation, the invention will be described herein in connection with various embodiments thereof. Those skilled in the art will recognize, however, that the features and advantages of the various embodiments of the invention may be implemented in a variety of configurations. It is to be understood, therefore, that the embodiments described herein are presented by way of illustration, not of limitation.

Various embodiments of the invention provide a cover or casing, for example, a symmetrical case (e.g., a plastic cover) that forms a complete assembly for capturing dust particles generated by electric rail systems, for example, a rail or track mounted surveillance system. The cover includes complementary portions that are connected together to form a dust collecting device. The two complementary portions may be mated together and secured, for example, by two push-in fasteners, and which creates one or more cavities around the collectors for collecting dust particles.

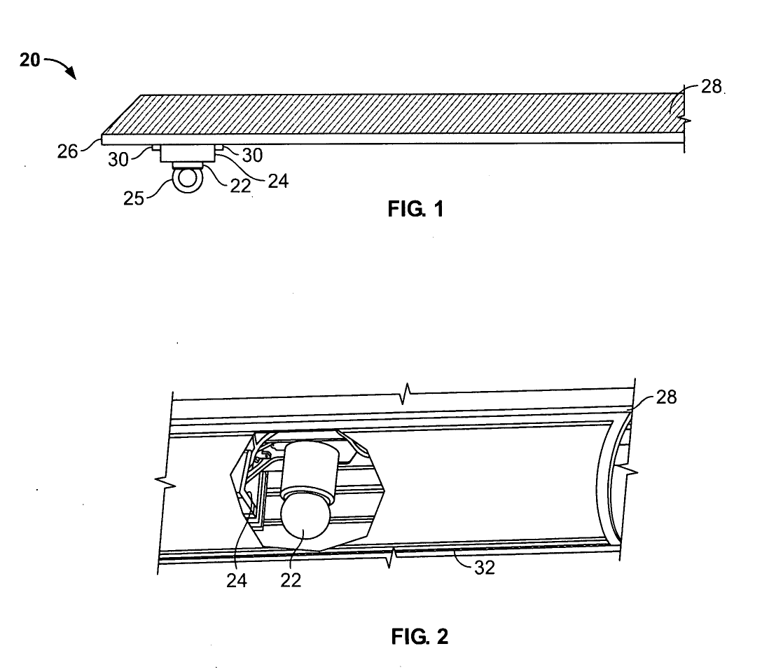

Various embodiments may be used in connection with different types of electric rail systems, for example, in connection with different types of electric rail or track mounted video surveillance systems. For example, as shown in FIG. 1, a surveillance system 20 may include a camera 22 (e.g., video camera) mounted on a moveable carriage or trolley 24. The camera 22 may include a housing 25 to form a dome type camera assembly. The trolley 24 may be movably connected, and more particularly, supported below a track or rail 26, which may be mounted to a support structure 28, for example, the ceiling of a building. The trolley 24 also may include a plurality of collectors 30, also referred to as collector brushes, as is known, for providing power to and communication with the camera 22 and trolley 24 via, for example, copper strips within the rail 26. A cowling 32 or other cover may be provided in connection with the rail 26 to conceal the camera 22 and trolley 24 as shown in FIG. 2 (showing a portion of the cowling 32 around the camera 22 transparent).

The camera 22 may be of any type including, for example, a dome type camera capable of rotating, pivoting and tilting operation, which may be controlled remotely in order to provide panning operation. Alternatively, a mirror assembly may be provided as is known to provide different panning views. Other components also may be provided in connection with the surveillance system 20. For example, a wireless communication system may be provided wherein a wireless antenna is provided at an end of the rail 26 and on the trolley 24.

The camera 22 may include a lens assembly 34 as is known and that is provided within the housing 25, which in one embodiment is a domed cover. The trolley 24 in various embodiments may include one or more collectors 30 mounted to each end of the trolley 24. The collectors 30 may include a connector portion 36 having an interface (not shown), for example, a connection interface for connecting to the trolley 24. Specifically, the collectors 30 may be connected to one of a motor 38 and a controller 40 that receives power and communicates through the collectors 30. The trolley 24 may include one or more different motors for controlling movement along the rail 26, for example, with a rail motor, or the movement of the lens assembly 36, for example, via a pan motor, a tilt motor, a zoom motor, etc. The collectors 30 may be connected to the motor 38 and/or controller 40 via a wired connection 42. Further, as is known, the collectors 30 may be spring mounted such that the collectors 30 are engaged (e.g., biased against) with the rail 26 when the trolley 24 is mounted thereto.

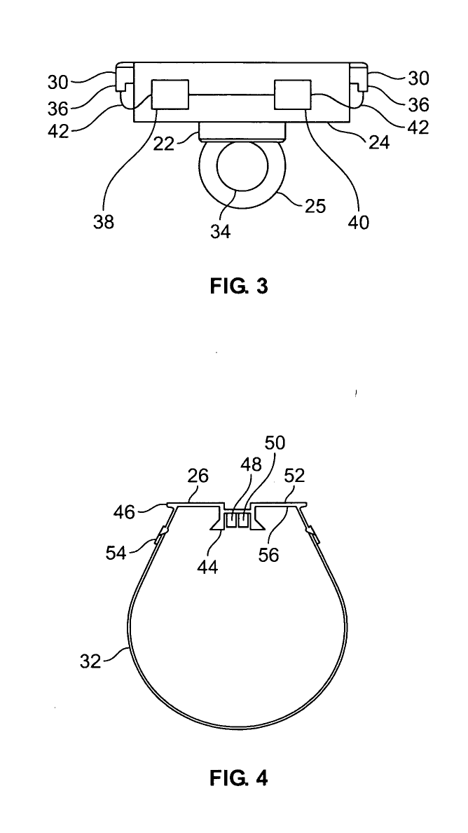

More particularly, as shown in FIG. 4, the rail 26 may include an engagement portion 44, for example, running rails for engaging the trolley 24 (shown in FIG. 3) and a mounting portion 46, for example, mounting rails for mounting the rail 26 to the support structure 28 (shown in FIG. 1). A plurality strips may be provided within the rail 26, which in an embodiment are copper strips including a communication strip 48 configured to communicate data and video, and a power strip 50 for providing power. Additionally, a ground plane 52 may be provided to ground the rail 26.

It should be noted that the cowling 32 may be mounted to the rail 26 at a cowling mounting slot 54. Additionally, means for tracking and/or identifying a particular camera 22 or trolley 24 may be provided, such as, for example, with a plurality of bar codes 56, radio-frequency identification (RFID) tags, etc. mounted at intervals along the rail 26.

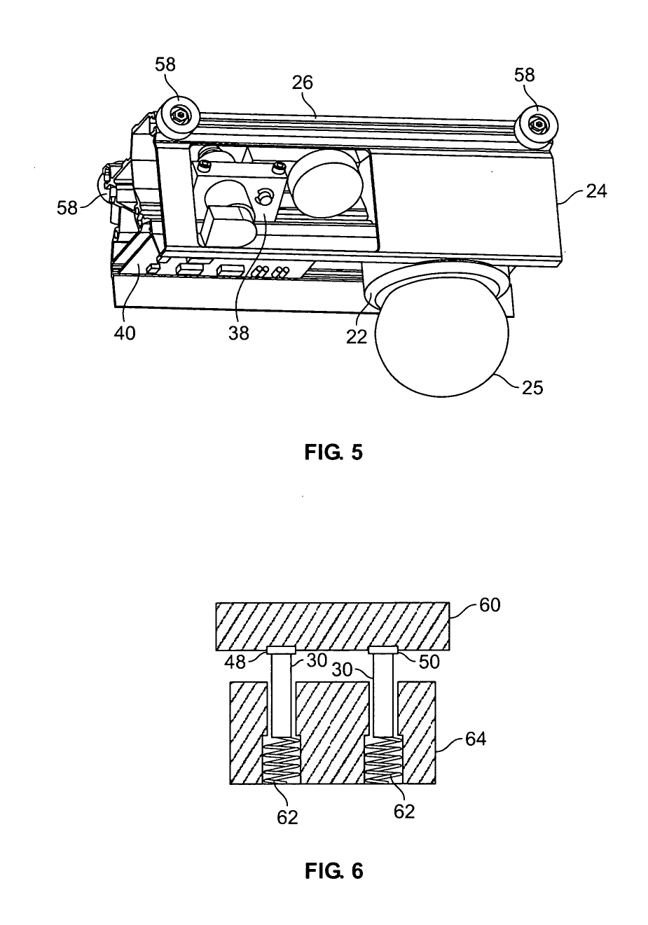

In operation, and as shown more clearly in FIG. 5, the trolley 24 may include a plurality of wheels 58 engaged with the rail 26 to provide movable operation of the camera 22 along the rail 26. A user control (not shown) also may be provided that may include a terminal having a processor/controller and user input, and a video display for displaying images from the camera 22 as is known.

Referring now to FIG. 6, power and control signals are provided to the trolley 24 and surveillance information (e.g., monitored video) is received from the trolley 24 along the rail 26 via the plurality of strips, for example, the power strip 50 and the communication strip 48, respectively, and that each extend longitudinally along the rail 26. The rail 26 may be formed of a plurality of sections. The communication strip 48 and the power strip 50 may be mounted within an isolation block 60 of the rail 26, and which may be made of electrically insulating material. It should be noted that the communication strip 48 and the power strip 50 are not limited to a strip type structure and may be modified, for example, and provided as conductors formed of cylindrical copper tubing mounted and supported within the isolation block 60. Each of the plurality of strips is in slidable contact along the length of rail 26 with at least one corresponding isolated collector 30, which may be an isolated slidable electrically conductive brush as is known. Each collector 30 is biased against the respective strip, for example, the communication strip 48 and the power strip 50 by a spring 62, which may be provided within a support member 64, and also made of electrically insulating material, and connected to the trolley 24 as shown in FIG. 3.

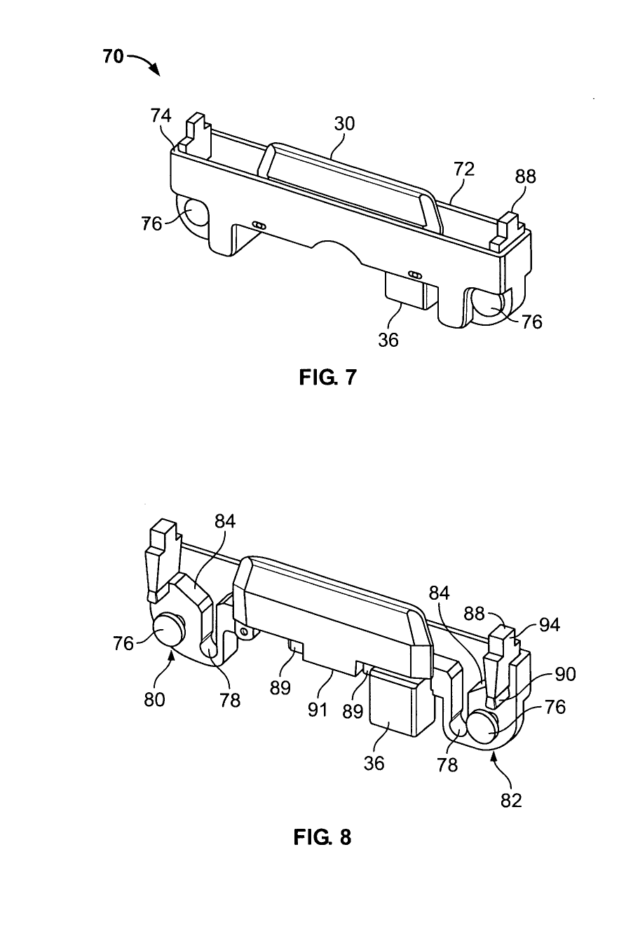

Various embodiments provide a cover 70 as shown in FIGS. 7 through 9 that may be configured to engage the collector 30. The cover 70 may be constructed for removable engagement to collector 30 and have a two-piece construction. More particularly, the cover 70 may include a first side member 72 and a second side member 74 configured to engage the collector 30. The first side member 72 and the second side member 74 may be constructed of any suitable material, for example, plastic. The first side member 72 and the second side member 74 may be mounted to the collector 30 using fastening components 76 (e.g., push pins) to form a housing structure with a cavity surrounding at least a portion of the collector 30. In an embodiment, the first side member 72 and the second side member 74 may have the same configuration, with each having a recess 78 on both of a first end 80 and a second end 82. The recess 78 of the first side member 72 and the second side member 74 together form a dust collecting cavity when the first side member 72 and the second side member 74 are engaged with the collector 30. The dust collecting cavity formed by the recess 78 of the first side member 72 and the second side member 74 has a depth greater than the width of the cavity, for example, a depth to width ratio of three to one. Additionally, the cavity may include a larger chamber or collection area at a lower end of the cavity.

An angled portion 84 may be provided generally above the recess 78 at both of the first end 80 and the second end 82. Further, the first side member 72 and the second side member 74 may include a first engagement portion 84, which in an embodiment, is a shoulder or edge extending longitudinally between the recesses 78 and which engages (e.g., abuts) a shoulder portion 86 of the collector 30. Additionally, the first side member 72 and the second side member 74 may include a second engagement portion 85, which in an embodiment, is a shoulder or edge extending longitudinally between the recesses 78 and which engages (e.g., abuts) a shoulder portion 87 of the collector 30. When the first side member 72 and the second side member 74 are fastened to the collector 30 with the fastening components 76, the complimentary shoulder arrangement resists and/or prevents disengagement or movement of the cover 70 relative to the collector 30. Essentially, the first side member 72 and the second side member 74 are formed to have portions complementary to portions of the collector 30 to provided secure engagement between the cover 70 and the collector 30.

Additionally, the first side member 72 and the second side member 74 may include collector alignment members, for example tabs 89. The tabs 89 may extend inwardly from the first side member 72 and the second side member 74 and may be configured to align and maintain the position the collector 30 within the cover 70. For example, a lower portion 91 of the collector 30 may abut and fit within the tabs 89. However, it should be noted that the configuration of the engagement portions 84 and 85 and alignment members of the cover 70 may be modified as desired or needed. For example, the shape, size, position, etc. of these elements may be changed or additional elements added based on the configuration of the collector 30 to be engaged within the cover 70.

Various embodiments also may include optional components. For example, a brush 88, and more particularly, a strip brush, may be provided at each of the first end 80 and the second end 82. The brush 88 may include an engagement portion 90 for engaging each of the first side member 72 and the second side member 74, for example, in a slot 92 of the first side member 72 and the second side member 74 generally located at the first end 80 and the second end 82, respectively. The brush 88 also may include a cleaning portion 94 configured to slidably engage one of the plurality of strips (shown in FIGS. 4 and 6).

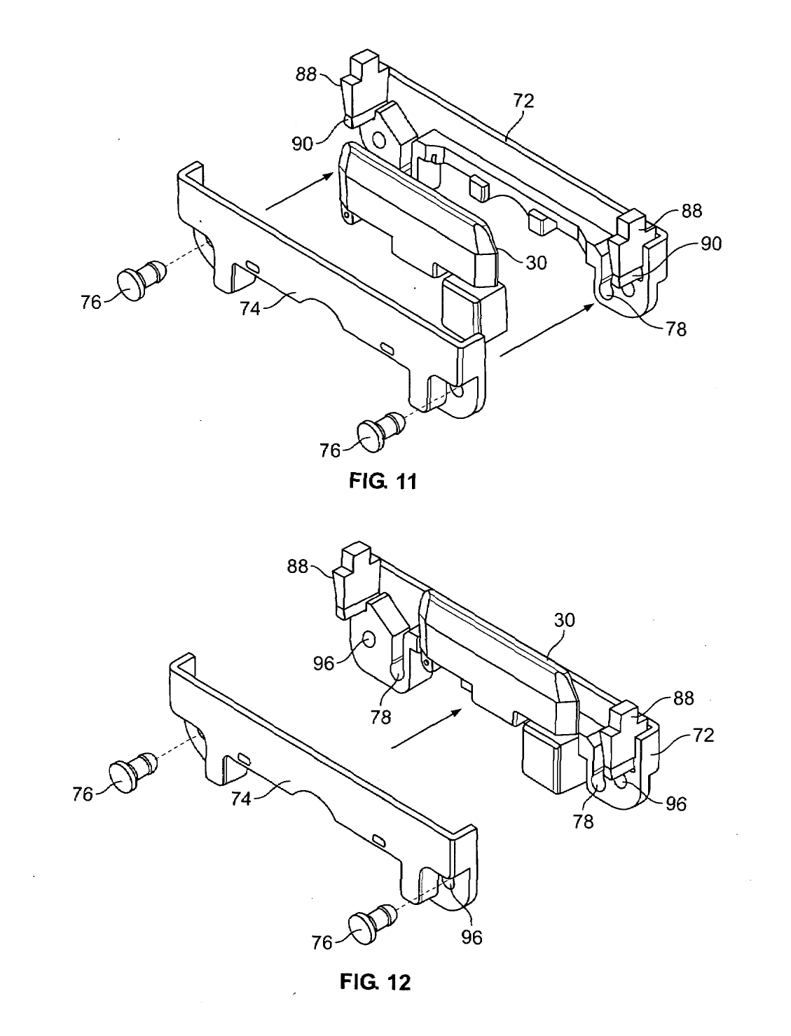

The assembly of the cover 70, and more particularly the engagement of the cover to the collector 30 is shown in FIGS. 10 through 13. If the cover 70 includes the brushes 88, then as shown in FIGS. 10 and 11, the engagement portions 90 of the brushes 88 are engaged with one of the side members, for example, the first side member 72, and more particularly, are engaged within the slots 92 of the first side member 72. The engagement portions 90 are configured to align with and fit within the slots 92. For example, a user may slide the engagement portions 90 into the slots 92 to hold the brushes 88 in position during the remaining assembly of the cover 70 to the collector 30.

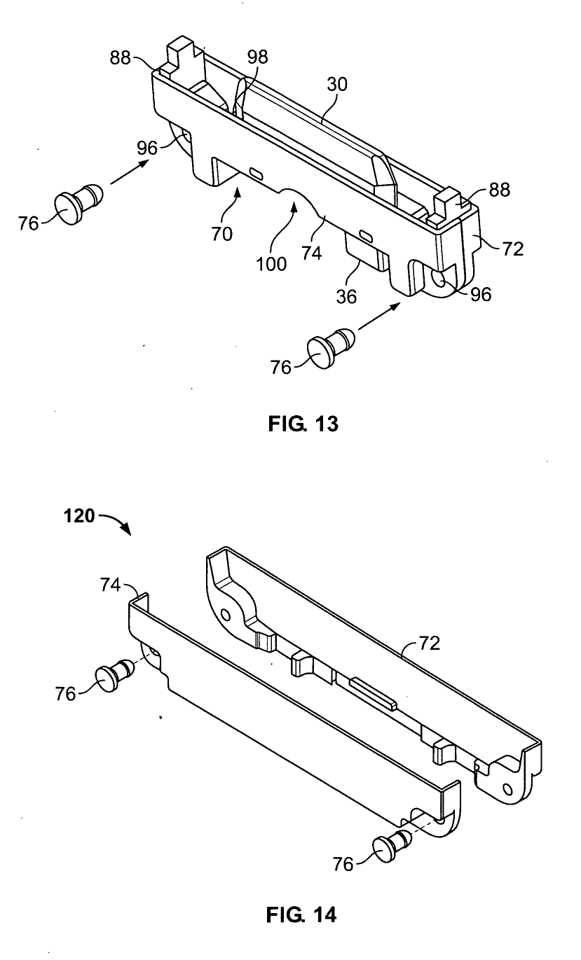

Thereafter, as shown in FIG. 12, the collector 30 is positioned adjacent one of the side members, for example, the first side member 72. More particularly, the collector 30 is aligned against the first side member 72 using the first engagement portion 84, the second engagement portion 85 and the tabs 89. The second side member 74 is then moved into engagement with the collector 30 opposite the first side member 72 and as shown in FIG. 13. The second side member 74 and collector 30 are aligned using the first engagement portion 84, the second engagement portion 85 and the tabs 89. In this position, apportion of the first side member 72 abuts a portion of the second side member 74 to form the cover 70 surrounding the collector 30. The cover 70 generally surrounds a lower half of the collector 30 and the recesses 78 of the first side member 72 and second side member 74 form dust collecting cavities or regions 98 on both the first end 80 and the second end 82 of the cover 70. With the cover 70 engaged surrounding the collector 30, the fastening components 76, which may be locking push pins, are inserted through aligned openings 96 of each of the first side member 72 and the second side member 74. In this engaged and locked position, the dust collecting cavities or regions 98 are configured to collect dust particles resulting from the operation of the collector 30 as described in more detail below.

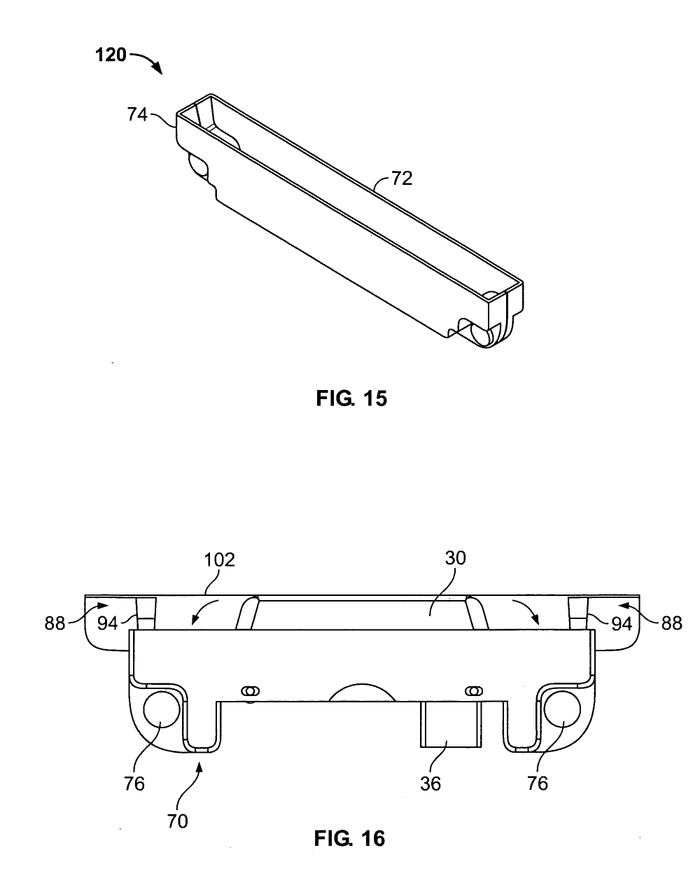

It should be noted that the shape, configuration and size of the cover 70 may be modified as desired or needed. For example, a recessed portion 100 may be formed to facilitate connection and engagement with the trolley 24 (shown in FIGS. 3 and 5). However, as shown in FIGS. 14 and 15, a cover 120 may be provided with no recessed portion 100. It should also be noted that the cover 120 does not include the brushes 88.

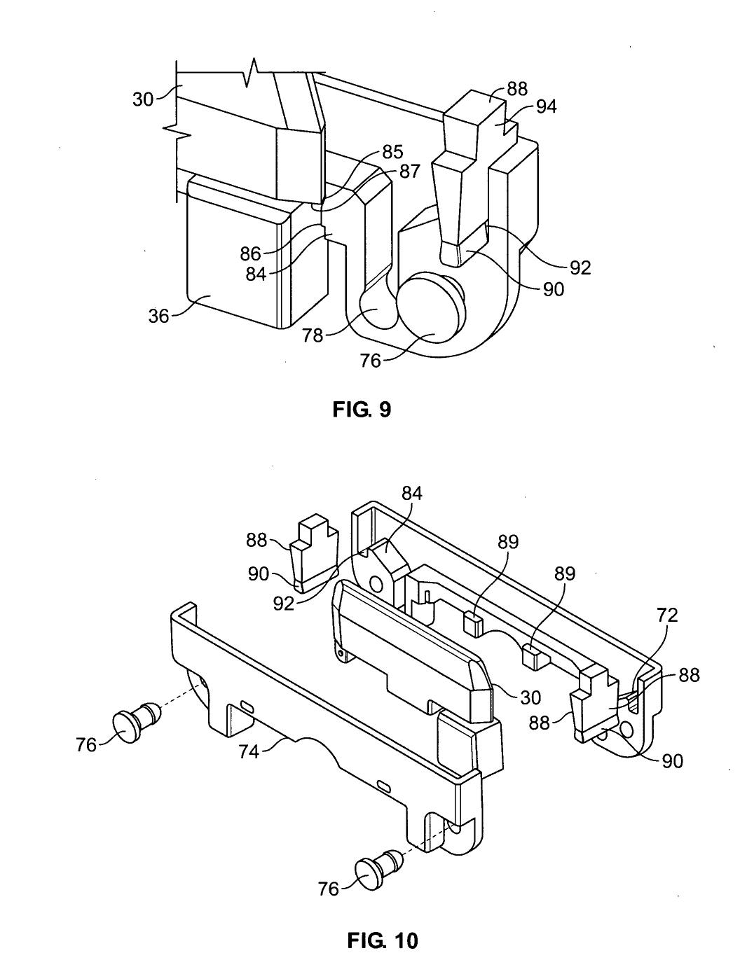

With respect to the collection of dust using the cover 70, FIG. 16 shows the collector 30 having the cover 70 engaged thereto with the collector in contact with a copper strip 102, for example, a communication strip or a power strip within the rail 26 of the surveillance system 20 (both shown in FIG. 1). It should be noted that the collector 30 is supported by the trolley 24 as shown in FIG. 1 and may make contact with the copper strip as shown in FIG. 6. As the trolley 24 moves along the rail 26, friction between the surface of the collector 30 and the surface of the copper strip 102 generates particles, for example graphite or metal dust particles, as the collector 30 wears down. The particles fall downward as indicated by the arrows in FIG. 16 and are collected within the cover 70, and more particularly, within the dust collecting regions 98. Specifically, the dust particles either fall directly into the dust collecting regions 98 or are directed into the dust collecting regions 98 by the angled portions 84 above the recesses 78 at both of the first end 80 and the second end 82 of each of the first side member 72 and the second side member 74 (all shown in FIGS. 8 and 9).

It should be noted that additional components may be provided to facilitate the collection of the particles. For example, the brushes 88 may be provided in connection with the cover 70 and configured such that the cleaning portions 94 of the brushes 88 slidably engage the copper strip 102 to direct the particles into the cover 70 as the collector 30 traverses the rail 26.

After a predetermined period of time (e.g., scheduled maintenance intervals), the collector 30 with the cover 70 may be removed from the surveillance system 20, and more particularly, disengaged from the rails 26 and the dust particles removed. The removal of the dust particles may be accomplished by disassembling the cover 70 by removing the fastening components 76. Thereafter a new cover 70 may be engaged with the collector 30 as described above. Alternatively, the removed cover 70 may be cleaned and reengaged with the collector 30.

It should be noted that the cover 70 may be used in connection with any type of collector and for any type of electric rail application.

Thus, various embodiments provide a cover having one or more cavities that collect dust particles from collectors (e.g., collection of over 80% of the particles generated during operation) used in electric rail applications, such as track mounted surveillance systems. The cleaning process may be simplified to unsnapping push-in buttons, holding the two portions of the cover together and disposing of the entire assembly. New parts may then be attached to the collectors before resuming operation. Alternatively, the cover may be cleaned and reattached to the collector. Accordingly, cleaning of the system, for example, cleaning of the cowling may be performed only once every two years or more.

Further, the various embodiments do not require any assembly tools for connecting the cover to the collectors with replacement performed relatively fast and inexpensively. The cleaning process may be bypassed by disposing of contaminated parts and replacing the parts with new parts, for example, a new cover. The various embodiments prevent the majority of the dust particles generated during operation from contaminating other components of the system, for example, the cowling, thereby reducing or eliminating the need for frequent cleaning operations. Further, the configuration of the cavity prevents or resists collected dust particles from being blown back out of the cavity on the cowling, which could be caused by turbulence generated while the trolley is moving at high speeds.

Further, it is to be understood that variations and modifications of the various embodiments of the present invention can be made without departing from the scope of the various embodiments. It is also to be understood that the scope of the various embodiments of the invention are not to be interpreted as limited to the specific embodiments disclosed herein, but only in accordance with the appended claims when read in light of the forgoing disclosure.

What is claimed is:

1. A collector cover comprising:
a first side member; and
a second side member, the first and second side members configured to engage a collector and to form at least one cavity.

2. A collector cover in accordance with claim 1 wherein the first side member and second side member each comprise a recess forming the at least one cavity when engaging the collector.

3. A collector cover in accordance with claim 1 wherein the at least one cavity is configured to receive therein particles from the collector.

4. A collector cover in accordance with claim 1 wherein each of the first side member and the second side member comprise an angled portion configured to direct particles from the collector into the at least one cavity.

5. A collector cover in accordance with claim 1 wherein each of the first side member and the second side member comprise at least one opening for receiving therethrough a removable fastening component when engaged with the collector.

6. A collector cover in accordance with claim 1 further comprising at least one brush configured to engage at least one end of each of the first and second side members and extend upwardly.

7. A collector cover in accordance with claim 1 further comprising at least one brush configured to engage at least one end of each of the first and second side members and engage a portion of a rail for an electric rail system.

8. A collector cover in accordance with claim 1 wherein the collector is configured to operate in connection with at least one of an electric rail system and a rail mounted surveillance system.

9. A collector cover in accordance with claim 1 wherein each of the first side member and second side member comprise alignment members configured to align the collector engaged therewith.

10. A collector cover in accordance with claim 1 wherein the first side member is configured to be removably fastened to the second side member.

11. A collector cover in accordance with claim 1 wherein the first side member and second side member are configured to together surround at least a lower portion of the collector and forming the at least one cavity at one end of the collector.

12. A collector cover in accordance with claim 1 wherein the at least one cavity has a depth greater than a width.

13. A collector cover in accordance with claim 1 wherein the at least one cavity comprises a collection area at a lower end of the at least one cavity.

14. A rail mounted electric surveillance system comprising:
at least one camera;
at least one rail;
a trolley configured to support the camera and movably engaged with the at least one rail;
at least one collector connected to the trolley and configured to contact at least a portion of the rail; and
a cover removably connectable to the at least one collector.

15. A rail mounted electric surveillance system in accordance with claim 14 further comprising at least one brush in connection with the cover configured to slidably engage the portion of the rail.

16. A rail mounted electric surveillance system in accordance with claim 14 wherein the cover comprises at least one cavity.

17. A rail mounted electric surveillance system in accordance with claim 14 wherein the cover comprises at least one angled portion for directing particles from the collector into a cavity.

18. A rail mounted electric surveillance system in accordance with claim 14 wherein the cover comprises a plurality of removably connectable members configured to be connected together with at least one push-in connector to engage the collector.

19. A method for reducing dust particle accumulation in an electric rail system, the method comprising:
configuring a cover to removably connect to a collector of the electric rail system; and
providing at least one cavity in the cover configured to collect therein dust particles from the collector.

20. A method in accordance with claim 19 further comprising providing at least one brush in connection with the cover configured to direct dust particles into the cavity.
